(19) United States
(12) Patent Application Publication
(10) Pub. No.: US 2008/0258651 A1
(43) Pub. Date: Oct. 23, 2008

(54) METHOD AND SYSTEM FOR OPEN LAMP PROTECTION

(75) Inventors: Yuancheng Ren, Hangzhou (CN); Kaiwei Yao, Santa Clara, CA (US); Wei Chen, Saratoga, CA (US)

Correspondence Address: PERKINS COIE LLP;PATENT-SEA, P.O. BOX 1247, SEATTLE, WA, 98111-1247, US

(73) Assignee: Monolithic Power Systems, Inc., San Jose, CA (US)

(21) Appl. No.: 12/145,350

(22) Filed: Jun. 24, 2008

Related U.S. Application Data
(63) Continuation of application No. 11/303,329, filed on Dec. 15, 2005, now Pat. No. 7,394,203.

(51) Int. Cl. H05B 41/36

(52) U.S. Cl. 315/291

(57) ABSTRACT

A detector circuit monitors the phase relationship between the lamp voltage and the excitation voltage, and if one or more conditions are met, triggers the open lamp protection process in a discharge lamp system. The detection circuit can be incorporated into a lamp voltage feedback circuit and implemented on the integrated circuit level with less cost and circuit complexity.

### TECHNICAL FIELD

The present invention relates to the driving of fluorescent lamps, and more particularly, to methods and protection schemes for driving cold cathode fluorescent lamps (CCFL), external electrode fluorescent lamps (EEFL), and flat fluorescent lamps (FFL).

### BACKGROUND OF INVENTION

Open lamp voltage schemes are often required in cold cathode fluorescent lamp (CCFL) inverter applications for safety and reliability reasons. In an open lamp condition, there might be a very large undesirable voltage occurring across the outputs if protections are not in place. This undesirable voltage may be several times higher than a nominal output and could be harmful to circuit components.

A conventional method to achieve open lamp voltage protection is to monitor the lamp current. The method is shown in FIG. 1 for in-phase applications and in FIG. 2 for out-of-phase applications. When lamp current becomes zero, the open lamp protection is triggered. In the open lamp protection circuits shown, an extra diode is needed for every lamp. Also, the open lamp detection circuit and the lamp voltage feedback circuit are independent. This results in undesired complexity of the overall circuit and associated high costs. A simpler open lamp protection method and circuit is needed.

### BRIEF DESCRIPTION OF DRAWINGS

The following figures illustrate embodiments of the invention. These figures and embodiments provide examples of the invention and they are non-limiting and non-exhaustive.

FIG. 1 An open lamp detection circuit for in-phase applications.

FIG. 2 An open lamp detection circuit for out-of-phase applications.

FIG. 3 Gain curves of a CCFL inverter.

FIG. 4 The phase relationship between lamp voltage V_{c} and excitation voltage Vᵢₙ under normal operation condition.

FIG. 5 The phase relationship between lamp voltage V_{c} and excitation voltage Vᵢₙ under open lamp condition.

FIG. 6 An open lamp protection method using the phase relationship between lamp voltage and excitation voltage.

FIG. 7 An open lamp protection circuit in single lamp application.

FIG. 8 Waveforms of dV [symbol] dt, V_{comp}, V_{center}, and Vₒᵤₜ in the circuit of FIG. 7 under normal operation condition.

FIG. 9 Waveforms of dV [symbol] dt, V_{comp}, V_{center}, and Vₒᵤₜ in the circuit of FIG. 7 under open lamp condition.

FIG. 10 An open lamp protection circuit in 4-lamp in-phase application.

FIG. 11 Waveforms of V_{c}, dV [symbol] dt, V_{comp}, V_{center}, and Vₒᵤₜ in the circuit of FIG. 10 under normal operation condition.

FIG. 12 Waveforms of V_{c}, dV [symbol] dt, V_{comp}, V_{center}, and Vₒᵤₜ in the circuit of FIG. 10 under open lamp condition.

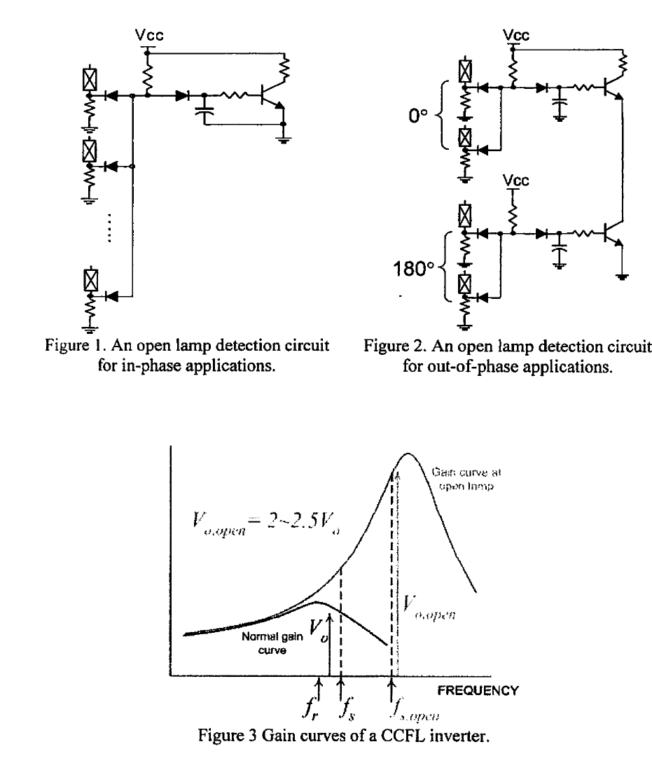

### DETAILED DESCRIPTION

Embodiments of a system and method that uses logic and discrete components to achieve open lamp voltage protection are described in detail herein. In the following description, some specific details, such as example circuits and example values for these circuit components, are included to provide a thorough understanding of embodiments of the invention. One skilled in relevant art will recognize, however, that the invention can be practiced without one or more specific details, or with other methods, components, materials, etc.

The following embodiments and aspects are illustrated in conjunction with systems, circuits, and methods that are meant to be exemplary and illustrative. In various embodiments, the above problem has been reduced or eliminated, while other embodiments are directed to other improvements.

The present invention relates to circuits and methods of open lamp voltage protection in discharge lamp applications. The circuits detect open lamp condition and trigger an open lamp protection process by monitoring the phase relationship between the lamp voltage and the excitation voltage that includes the voltage across the transformer.

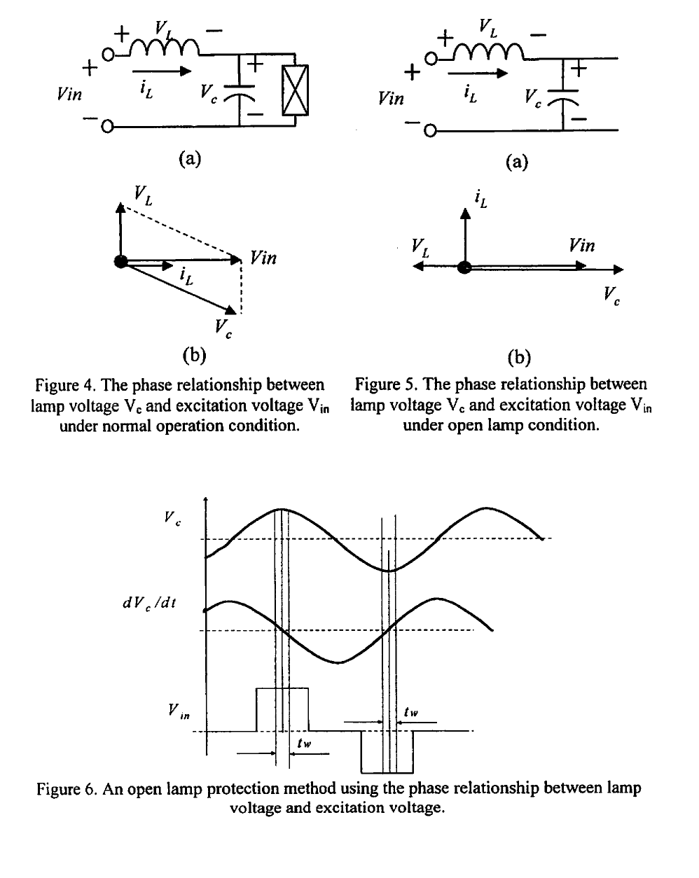

FIG. 3 shows gain curves of a typical CCFL inverter. Under normal operation, the inverter works with a switching frequency fₛ, which is close to a resonant frequency fᵣ in the inductive region of the bottom gain curve. Under an open lamp condition, the inverter works with fₛ in the capacitive region of the top gain curve. A CCFL lamp circuit under normal operation is plotted in FIG. 4(a). As indicated in the circuit, the input current i_{L} and the excitation voltage Vᵢₙ are almost in phase. Further, the phase of the lamp voltage V_{c} lags compared to the phase of Vᵢₙ. The relationship between i_{L}, Vᵢₙ, the inductor voltage V_{L}, and V_{c} under normal operation is illustrated in the vector diagram of FIG. 4(b).

The CCFL lamp circuit under an open lamp condition is shown schematically in FIG. 5(a). As indicated in the circuit, i_{L} and Vᵢₙ have almost 90 degrees phase difference. And V_{c} and Vᵢₙ are almost in phase. The relationship between i_{L}, Vᵢₙ, V_{L}, and V_{c} under open lamp condition is illustrated in the vector diagram of FIG. 5(b). As seen, there is a significantly different phase relationship between V_{c} and Vᵢₙ under normal operation and open lamp condition. In accordance to one embodiment of this invention, the phase difference between V_{c} and Vᵢₙ is monitored and used for open lamp protection. The phase difference is used to trigger an open lamp protection process. When the open lamp protection process is triggered, the circuit increases the switching frequency fₛ hence the gain of lamp voltage. If the open lamp condition persists after a predetermined waiting time, the circuit shuts down immediately to prevent a potential over-voltage and damages to electronic components. Note that since the gate voltage of the power device has the same phase as that of Vᵢₙ in some applications, the phase difference between gate voltage and V_{c} can also be used for open lamp protection. The power device is the one or more power transistors used to invert the DC power source into AC power for transmission into a transformer. Furthermore, the comparison between gate voltage and V_{c} can be done on the integrated circuit level.

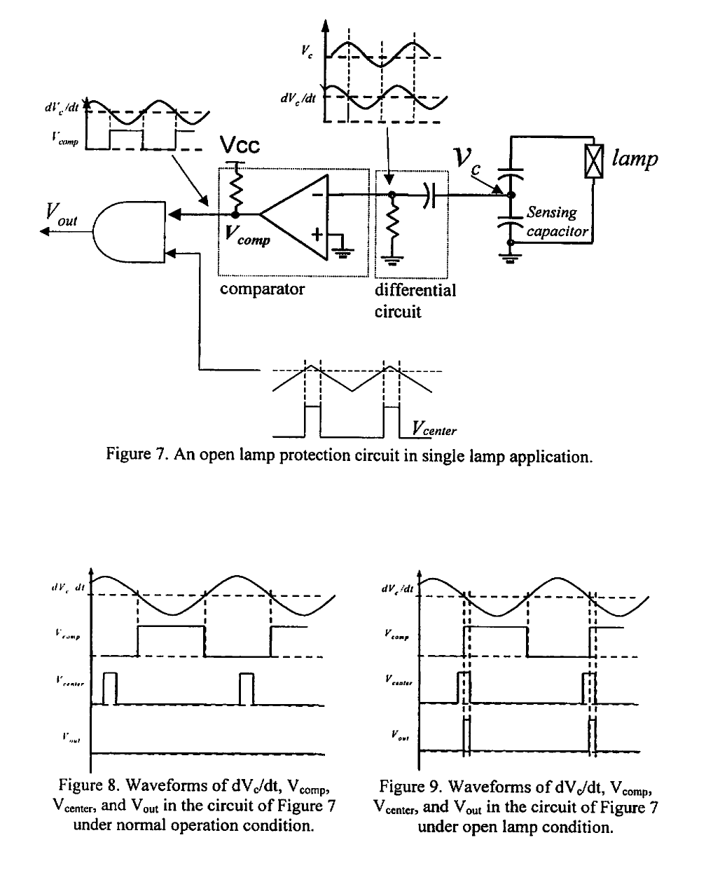

One method for monitoring the phase difference between V_{c} and Vᵢₙ is illustrated in FIG. 6. The slew rate of the lamp voltage dV_{c}/dt is calculated and obtained. There is a detection window t_{W} located in the middle of the Vᵢₙ pulse. If dV [symbol] dt changes from positive to negative, or vice versa, within t_{W}, the open lamp protection process is triggered. If dV [symbol] dt changes its sign, outside t_{W}, the open lamp protection process will not be triggered. An embodiment of this invention for a single lamp application is shown in FIG. 7. The sensed lamp voltage, V_{c}, is coupled to a differential circuit, which comprises a capacitor and a grounded resistor. The output of the differential circuit, dV [symbol] dt, is coupled to the negative terminal of a comparator whose positive terminal is coupled to ground or a threshold voltage Vₜₕ. The output of the comparator, V_{comp}, is coupled to an input terminal of an AND gate and a voltage source V_{cc} through a resistor. The other input terminal of the AND gate is coupled to V_{center}, which is generated by a triangular waveform and a DC level. V_{center} represents the middle portion of Vᵢₙ. Since the triangular waveform is also used to generate the duty cycle of the discharge lamp inverter, the phase of the pulse is exactly the same as that of Vᵢₙ. The DC level is used to adjust the width of t_{W}.

FIG. 8 shows the waveforms of dVc/dt, Vcomp, Vcenter, and Vout in the circuit of FIG. 7 under normal operation condition. Under normal condition, dV [symbol] dt changes its sign outside t_{W}. The comparator compares dV [symbol] dt and zero voltage to generate the pulse V_{comp}, which is also outside V_{center}. The output of the AND gate, Vₒᵤₜ, is always low and open lamp protection process is not triggered. FIG. 9 shows the waveforms of dV [symbol] dt, V_{comp}, V_{center}, and Vₒᵤₜ in the circuit of FIG. 7 under open lamp condition. When an open lamp condition occurs, dV [symbol] dt changes its sign within V_{center} and V_{comp} overlaps with V_{center}. A pulse is generated in every cycle to trigger the open lamp protection process.

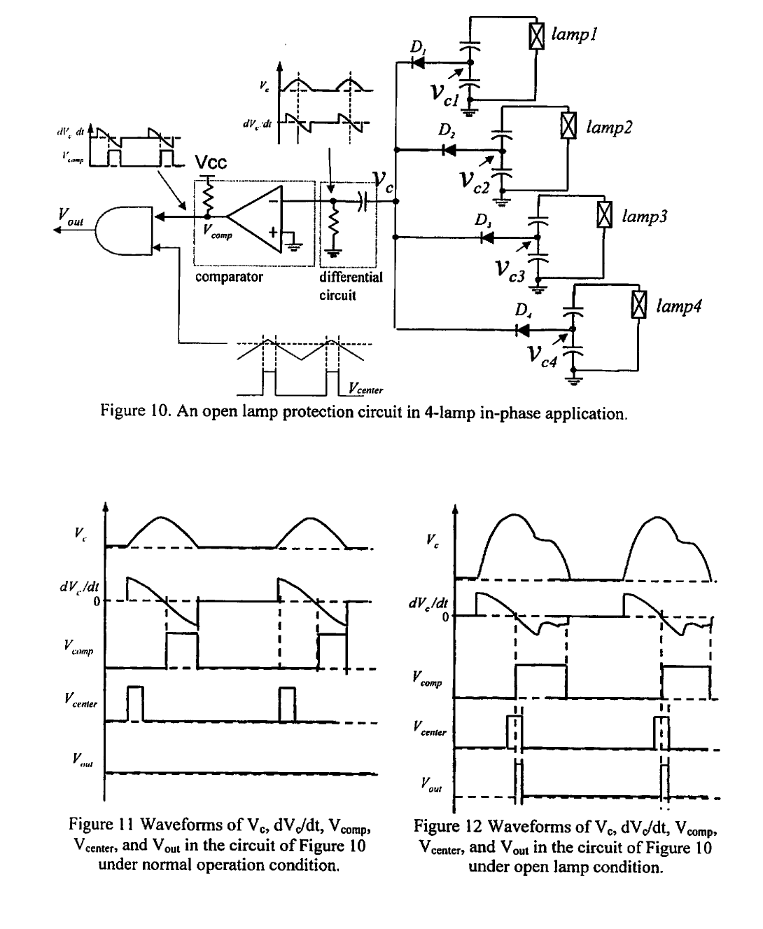

Another embodiment of this invention is shown in FIG. 10 for multiple lamp applications. For simplicity of discussion, a 4-lamp in-phase application is discussed. Each sensed lamp voltage, V_{c1} to V_{c4}, is coupled to the input terminal of a differential circuit through its corresponding diode, D1 to D4. All diodes have an OR gate configuration so that the input signal V_{c} for the differential circuit follows the largest Vci value, wherein i is between 1 and 4. Like in a single-lamp application, V_{c} is coupled to a capacitor and a grounded resistor. The output of the differential circuit, dV [symbol] dt, is coupled to the negative terminal of a comparator while the positive terminal of the comparator is coupled to ground or a threshold voltage Vₜₕ. The output of the comparator, V_{comp}, is coupled to an input terminal of an AND gate and a voltage source V_{cc} through a resistor. The other input terminal of the AND gate is couple to V_{center}, which is generated by a triangular waveform and a DC level. V_{center} represents the middle portion of Vᵢₙ. Since the triangular waveform is also used to generate the duty cycle of the discharge lamp inverter, the phase of the pulse is exactly the same as that of Vᵢₙ. The DC level is used to adjust the width of t_{W}. FIG. 11 shows the waveforms of dV [symbol] dt, V_{comp}, V_{center}, and Vₒᵤₜ in the circuit of FIG. 10 under normal operation condition. Under normal operation condition, dV [symbol] dt changes its sign outside t_{W}. The comparator compares dV [symbol] dt and zero voltage to generate the pulse V_{comp}, which is also outside V_{center}. The output of the AND gate, Vₒᵤₜ, is always low and open lamp protection process is not triggered. FIG. 12 shows the waveforms of dV [symbol] dt, V_{comp}, V_{center}, and Vₒᵤₜ in the circuit of FIG. 10 under open lamp condition. When one or more lamps are open, there are two peaks in each waveform cycle of V_{c}. The higher peak is from the sensed voltage from opened lamps while the lower peak is from lamps under normal condition. The slew rate dV [symbol] dt changes its sign within V_{center} and V_{comp} overlaps with V_{center}. A pulse is generated in every cycle to trigger the open lamp protection process.

In one embodiment of the present invention, a detection circuit is used to monitor the phase relationship between the lamp voltage V_{c} and the excitation voltage Vᵢₙ in a single-lamp or multiple-lamp system, and trigger the open lamp protection process when one or more lamps are open. Under normal operation condition, the phase difference between V_{c} and Vᵢₙ is large, typical more than 30 degrees; while under open lamp condition, the phase difference is close to zero degrees. In another embodiment of the present invention, the detection circuit calculates the slew rate of the sensed lamp voltage dV [symbol] dt and compares it with a detection window t_{W} which is located in the middle of Vᵢₙ pulse. If dV [symbol] dt changes from positive to negative, or vice versa, within t_{W}, the open lamp protection process is triggered. If dV [symbol] dt changes its sign, outside t_{W}, the open lamp protection process will not be triggered. One advantage of the present invention is that the lamp current detection circuit is not needed. The detection circuit can be incorporated into a lamp voltage feedback circuit to monitor and trigger the open lamp protection. Also, the detection circuit can be implemented on the integrated circuit level with less cost and circuitry complexity.

The description of the invention and its applications as set forth herein is illustrative open lamp voltage protection and is not intended to limit the scope of the invention. Variations and modifications of the embodiments disclosed herein are possible, and practical alternatives to and equivalents of the various elements of the embodiments are known to those of ordinary skill in the art. Other variations and modifications of the embodiments disclosed herein may be made without departing from the scope and spirit of the invention.

1-10. (canceled)

11. A method for detecting an open lamp condition in a discharge lamp system, comprising:
monitoring the phase relationship between the lamp voltage of at least one discharge lamp and the gate voltage of at least one power device through a detector circuit;
deriving a voltage signal from said detector circuit; and
if said voltage signal satisfies an open lamp condition, triggering an open lamp protection process.

12. The method in claim 11, wherein said open lamp protection process is triggered when said phase relationship is approximately to zero degrees.

13. The method in claim 12, further comprising:
deriving the slew rate of said lamp voltage;
deriving a detection window located in the middle of the pulse of said excitation voltage or gate voltage of the power devices;
comparing said slew rate with said detection window; and
if said slew rate changes its signal within said detection window, triggering an open lamp protection process.

14. The method in claim 13, wherein said detection circuit comprises:
a sensing capacitor being coupled to the at least one discharge lamp;
a differential circuit with its input terminal being coupled to said sensing capacitor;
a comparator with its negative terminal being coupled to the output terminal of said differential circuit and its positive terminal being coupled to ground or a threshold voltage; and
an AND gate with one input terminal being coupled to the output terminal of said comparator and the other input terminal being coupled to a pulse signal representing the middle portion of the excitation voltage.

15. The method in claim 14, wherein said pulse signal is generated by a DC level and a triangular waveform that is also used to generate the duty cycle of said discharge lamp system.

16. The method in claim 14, wherein said first differential circuit comprises:
a capacitor being coupled to said sensing capacitor; and
a grounded resistor being coupled to said capacitor and the negative terminal of said comparator.

17. The method in claim 14, wherein said detection circuit comprises:
a plurality of sensing capacitors being coupled to an associated one of said at least one discharge lamp and the voltages of said plurality of sensing capacitors are in phase;
a plurality of diodes being coupled to said plurality of sensing capacitors wherein one diode corresponds to one sensing capacitor;
a differential circuit with its input terminal being coupled to said plurality of diodes;
a comparator with its negative terminal being coupled to the output terminal of said differential circuit and its positive terminal being coupled to ground or a threshold voltage; and
an AND gate with one input terminal being coupled to the output terminal of said comparator and the other input terminal being coupled to a pulse signal representing the middle portion of the excitation voltage.

18. A circuit capable of detecting an open lamp condition, and triggering an open lamp protection process in a discharge lamp system, comprising:
a sensing capacitor being coupled to a discharge lamp;
a differential circuit with its input terminal being coupled to said sensing capacitor;
a comparator with its negative terminal being coupled to the output terminal of said differential circuit and its positive terminal being coupled to ground or a threshold voltage; and
an AND gate with one input terminal being coupled to the output terminal of said comparator and the other input terminal being coupled to a pulse signal representing the middle portion of the excitation voltage.

19. The circuit in claim 18, wherein said differential circuit comprises:
a capacitor being coupled to said sensing capacitor; and
a grounded resistor being coupled to said capacitor and the negative terminal of said comparator.

20. The circuit in claim 18, wherein said circuit is integrated onto a single integrated circuit die.

21. The circuit in claim 18, wherein said pulse signal is generated by a DC level and a triangular waveform that is also used to generate the duty cycle of said discharge lamp system.

22. A circuit for detecting an open lamp condition in a discharge lamp system, comprising:
means for monitoring the phase relationship between the lamp voltage of at least one discharge lamp and the gate voltage of at least one power device through a detector circuit;
means for deriving a voltage signal from said detector circuit; and
logic means operative such that if said voltage signal satisfies an open lamp condition, triggering an open lamp protection process.

23. The circuit of claim 22, wherein said open lamp protection process is triggered when said means for monitoring the phase relationship indicates an approximately zero degree phase difference.

24. The circuit of claim 23, further comprising:
means for deriving the slew rate of said lamp voltage;
means for deriving a detection window located in the middle of the pulse of said excitation voltage or gate voltage of the power devices;
means for comparing said slew rate with said detection window; and
logic means operative such that if said slew rate changes its signal within said detection window, triggering an open lamp protection process.
